(19) United States
(12) Patent Application Publication
(10) Pub. No.: US 2023/0318338 A1
(43) Pub. Date: Oct. 5, 2023

(54) CONTROL APPARATUS, MOVING OBJECT, AND METHOD

(71) Applicant: HONDA MOTOR CO.,LTD., Tokyo (JP)

(72) Inventors: Akira SAITA, Tokyo (JP); Yuki ITO, Tokyo (JP); Hiroto OKABE, Tokyo (JP)

(21) Appl. No.: 18/187,684

(22) Filed: Mar. 22, 2023

(30) Foreign Application Priority Data
Mar. 30, 2022 (JP) 2022-055594

(51) Int. Cl. H02J 7/00; B60L 53/62; B60L 55/00

(52) U.S. Cl. CPC H02J 7/007; B60L 53/62; B60L 55/00; H02J 7/00032

(57) ABSTRACT

There is provided a control apparatus including: a guarantee application determination unit configured to determine whether a battery included in a moving object satisfies a predetermined guarantee application condition; and a limitation unit configured to limit an amount of power which is discharged from the battery to an outside of the moving object, to be lower than or equal to a first limit value, when the battery satisfies the guarantee application condition, in which the limitation unit is configured to limit, or not to limit the amount of power which is discharged from the battery to the outside of the moving object, to be lower than or equal to a second limit value which is higher than the first limit value, when the battery does not satisfy the guarantee application condition.

The contents of the following Japanese patent application(s) are incorporated herein by reference:

NO. 2022-055594 filed on Mar. 30, 2022.

### BACKGROUND

### 1. Technical Field

The present invention relates to a control apparatus, a moving object, and a method.

### 2. Related Art

In recent years, research and development has been carried out on a secondary battery that contributes to an energy efficiency for more people to be able to secure access to affordable, reliable, sustainable, and advanced energy. Patent Documents 1 to 4 disclose techniques relating to a charge and a discharge of a secondary battery included in a vehicle. Prior Art Document

### Patent Document 1: Japanese Patent No. 6596472

### Patent Document 2: Japanese Patent No. 6918877

### BRIEF DESCRIPTION OF THE DRAWINGS

FIG. 1 conceptually shows a mode of use of a system 5 in one embodiment.

FIG. 2 conceptually shows a configuration of a power storage system 18 included in a vehicle 10.

FIG. 3 shows an example of a system configuration of a control apparatus 100.

FIG. 4 shows an example of a system configuration of a control apparatus 20.

FIG. 5 shows an example of controlling, according to elapsed years, a limitation state of an amount of power which is transmitted and received between a battery 12 and a power grid 90.

FIG. 6 shows an example of controlling, according to a virtual distance, the limitation state of the amount of power which is transmitted and received between the battery 12 and the power grid 90.

FIG. 7 shows a transition of a control value when a charge and discharge control of the battery 12 is performed by a control apparatus 170.

FIG. 8 shows an example of controlling, according to a usage amount of electrical equipment 14, the limitation state of the amount of power which is transmitted and received between the battery 12 and the power grid 90.

FIG. 9 is a diagram for describing a parameter which is used for a power transmission and reception control between the power grid 90 outside the vehicle 10, and the battery 12.

FIG. 10 conceptually shows changes in remaining amount of power capable of being discharged and in reference amount of power capable of being discharged.

FIG. 11 is diagram for describing a control of a limitation unit 240.

FIG. 12 shows an example of a computer 2000.

### DESCRIPTION OF EXEMPLARY EMBODIMENTS

Hereinafter, embodiments of the present invention will be described, but the embodiments do not limit the invention according to the claims. In addition, not all of the combinations of features described in the embodiments are essential for a solving means of the invention.

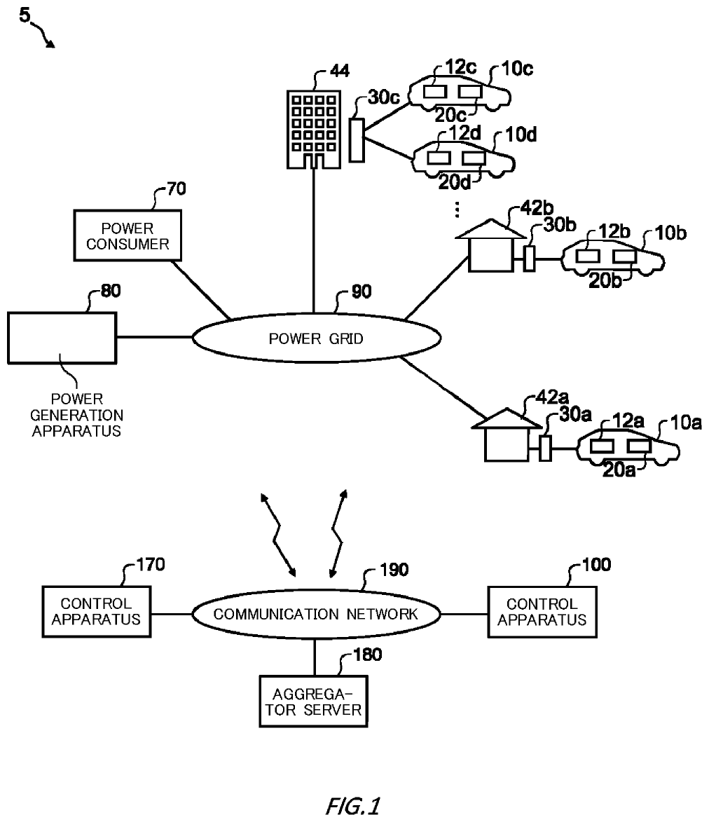

FIG. 1 conceptually shows a mode of use of a system 5 in one embodiment. The system 5 includes a charging and discharging facility 30a, a charging and discharging facility 30b, and a charging and discharging facility 30c, a power generation apparatus 80, a control apparatus 100, a control apparatus 170, an aggregator server 180, a vehicle 10a, a vehicle 10b, a vehicle 10c, and a vehicle 10d.

The vehicle 10a, the vehicle 10b, the vehicle 10c, and the vehicle 10d respectively include a battery 12a, a battery 12b, a battery 12c, and a battery 12d. The vehicle 10a, the vehicle 10b, the vehicle 10c, and the vehicle 10d respectively include a control apparatus 20a, a control apparatus 20b, a control apparatus 20c, and a control apparatus 20d. In the present embodiment, the vehicle 10a, the vehicle 10b, the vehicle 10c, and the vehicle 10d may be collectively referred to as a “vehicle 10”. The battery 12a, the battery 12b, the battery 12c, and the battery 12d may be collectively referred to as a “battery 12”. The control apparatus 20a, the control apparatus 20b, the control apparatus 20c, and the control apparatus 20d may be collectively referred to as a “control apparatus 20”. The charging and discharging facility 30a, the charging and discharging facility 30b, and the charging and discharging facility 30c may be collectively referred to as a “charging and discharging facility 30”.

The control apparatus 100 is connected to the aggregator server 180 through a communication network 190. The control apparatus 100 is able to communicate with the charging and discharging facility 30 through the communication network 190. The control apparatus 100 controls the charging and discharging facility 30 through the communication network 190. The control apparatus 100 communicates with the control apparatus 20 of the vehicle 10 through the communication network 190, and acquires various pieces of information of the vehicle 10 including a travel history of the vehicle 10, and an SOC and an SOH of the battery 12.

The charging and discharging facility 30, a power consumer 70, and the power generation apparatus 80 are connected to a power grid 90. The power generation apparatus 80 includes, for example, a power plant operated by an electric power company. Power generated by the power generation apparatus 80 is able to be supplied to the charging and discharging facility 30 and the power consumer 70 through the power grid 90. The power grid 90 is, for example, a power system.

The charging and discharging facilities 30 charge and discharge the batteries 12 mounted on the vehicles 10 that are respectively connected to the charging and discharging facilities 30. The vehicle 10 is, for example, an electric vehicle. The battery 12 is a battery that supplies the power for travel of the vehicle 10. The vehicle 10 may be a privately owned vehicle, a vehicle that is used for business by a business operator, a shared car, or the like.

The charging and discharging facility 30a is provided in a dwelling unit 42a, and charges and discharges the battery 12a of the vehicle 10a that is connected to the charging and discharging facility 30a. When the battery 12a is discharged, the power which is provided from the battery 12a may be consumed by a power load in the dwelling unit 42a, or provided to the power grid 90 through a power line installed in the dwelling unit 42a. The charging and discharging facility 30b is provided in a dwelling unit 42b, and charges and discharges the battery 12b of the vehicle 10b that is connected to the charging and discharging facility 30b. When the battery 12b is discharged, the power which is provided from the battery 12b is consumed by a power load in the dwelling unit 42b, or provided to the power grid 90 through a power line installed in the dwelling unit 42b. The charging and discharging facility 30c is a charging and discharging facility provided in a facility 44, and charges and discharges the battery 12c and the battery 12d mounted on the vehicle 10c and the vehicle 10d connected to the charging and discharging facility 30c. When the battery 12c and the battery 12d are discharged, the power which is provided from the battery 12c and the battery 12d may be consumed by a power load in the facility 44, or provided to the power grid 90 through a power line installed in the facility 44.

Each charging and discharging facility 30 can charge the battery 12 with the power received from the power grid 90. The charging and discharging facility 30 can discharge the battery 12 and transmit the power to the power grid 90.

When the power is transmitted and received between the power grid 90 and the battery 12, the charging and discharging facility 30 and the control apparatus 20 of the vehicle 10 charge and discharge the battery 12 according to a control of the control apparatus 100. For example, when there occurs a power shortage in the power grid 90, the control apparatus 100 can cause the power to be transmitted from the battery 12 to the power grid 90, by instructing the charging and discharging facility 30 and the control apparatus 20 to discharge the battery 12. When there is a power surplus in the power grid 90, the control apparatus 100 can reduce the power surplus of the power grid 90, by instructing the charging and discharging facility 30 and the control apparatus 20 to charge the battery. In this way, the control apparatus 100 can cooperate with the charging and discharging facility 30 and the control apparatus 20 to provide a primary adjustment capacity, a secondary adjustment capacity, a tertiary adjustment capacity, and the like, in the power grid 90. This makes it possible for the control apparatus 100 to aggregate a plurality of batteries 12 mounted on a plurality of vehicles 10 and provide power resources to the power grid 90.

The aggregator server 180 is, for example, a server used by a power aggregator. The aggregator server 180 conducts power trading in a power market. The control apparatus 100 communicates with the aggregator server 180 to provide a required amount of power to the power grid 90. For example, the control apparatus 100 controls, according to a demand from the aggregator server 180, the charging and discharging facility 30 and the control apparatus 20 to charge and discharge the battery 12, and provides an amount of power in accordance with the demand.

The control apparatus 170 is a control apparatus different from the control apparatus 100. For example, the control apparatus 100 is a specific control apparatus that holds specific information for a charge and discharge control of the battery 12 included in the vehicle 10. The control apparatus 100 may be a control apparatus dedicated to the vehicle 10. On the other hand, the control apparatus 170 is a control apparatus that performs normal charge and discharge controls on the battery 12 included in the vehicle 10, and a battery included in another vehicle other than the vehicle 10.

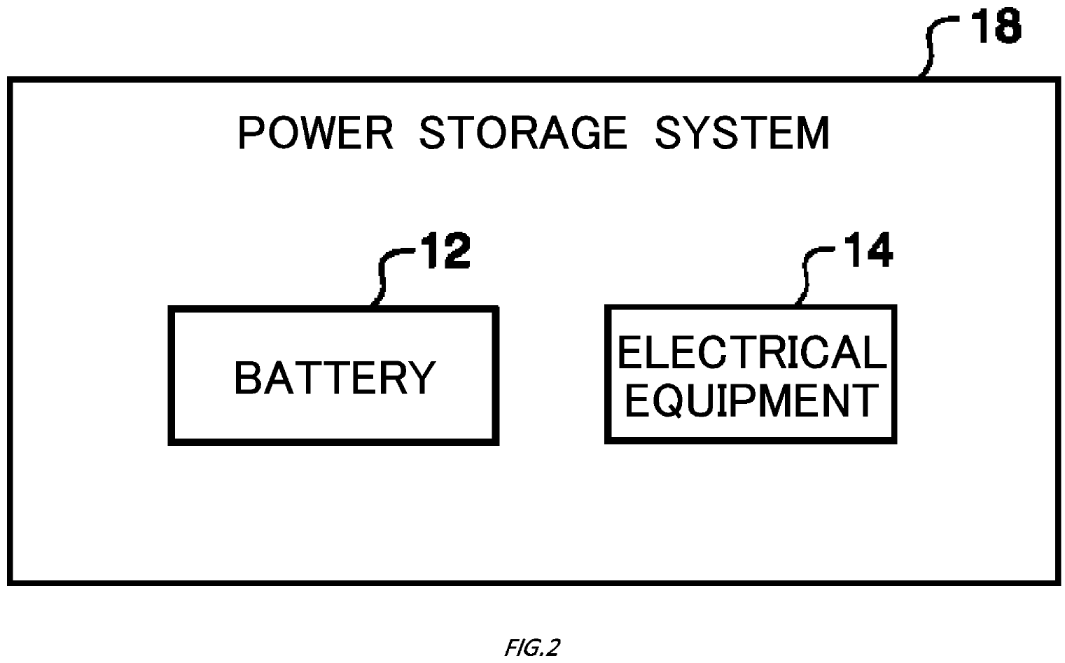

FIG. 2 conceptually shows a configuration of a power storage system 18 included in a vehicle 10. The power storage system 18 includes the battery 12 and electrical equipment 14. The electrical equipment 14 is electrical equipment that is required to be operated for the battery 12 to be charged and discharged. The electrical equipment 14 includes: an electric component such as a relay, a switch, and a DC-DC converter; control equipment such as an ECU (Electronic Control Unit); communication equipment such as a TCU (Telematics Control Unit); or the like. The electrical equipment 14 at least partially includes the control apparatus 20.

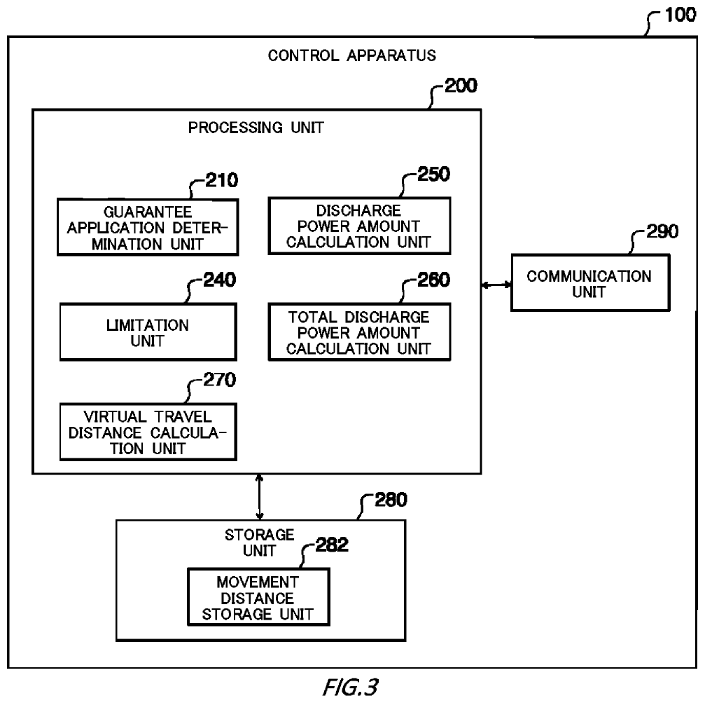

FIG. 3 shows an example of a system configuration of a control apparatus 100. The control apparatus 100 includes a processing unit 200, a storage unit 280, and a communication unit 290.

The processing unit 200 controls the communication unit 290. The communication unit 290 is responsible for a communication between the aggregator server 180 and the vehicle 10. The processing unit 200 is realized by a calculation processing device including a processor. The storage unit 280 is realized by including each non-volatile storage medium. The processing unit 200 performs processing by using information stored in the storage unit 280. The processing unit 200 may be realized by a microcomputer including a CPU, a ROM, a RAM, an I/O, a bus, and the like. The control apparatus 100 may be realized by a computer.

In the present embodiment, the control apparatus 100 is set to be realized by a single computer. However, in another embodiment, the control apparatus 100 may be realized by a plurality of computers. At least some functions of the control apparatus 100 may be realized by one or more servers, such as a cloud server.

The processing unit 200 includes a guarantee application determination unit 210, a limitation unit 240, a discharge power amount calculation unit 250, a total discharge power amount calculation unit 260, and a virtual travel distance calculation unit 270. The storage unit 280 includes a movement distance storage unit 282.

The guarantee application determination unit 210 is configured to determine whether the battery 12 included in the vehicle 10 satisfies a predetermined guarantee application condition. The limitation unit 240 is configured to limit an amount of power which is discharged from the battery 12 to an outside of the vehicle 10, to be lower than or equal to a first limit value, when the battery 12 satisfies the guarantee application condition. The limitation unit 240 is configured to limit, or not to limit the amount of power which is discharged from the battery 12 to the outside of the vehicle 10, to be lower than or equal to a second limit value which is higher than the first limit value, when the battery 12 does not satisfy the guarantee application condition.

The guarantee application determination unit 210 is configured to determine that the guarantee application condition is not satisfied when a usage time from a start date of use of the vehicle 10 is greater than or equal to a predetermined value, when a virtual travel distance is greater than or equal to a predetermined value, or when a total amount of discharge of the battery 12 is greater than or equal to a predetermined threshold value.

The movement distance storage unit 282 is configured to store a movement distance of the vehicle 10 during the usage time. The discharge power amount calculation unit 250 is configured to calculate the amount of power discharged from the battery 12 to the outside of the vehicle 10 during the usage time. The total discharge power amount calculation unit 260 is configured to calculate the total amount of discharge by summing a value obtained by converting the movement distance stored in the movement distance storage unit into an amount of power, and an amount of power calculated by the discharge power amount calculation unit.

The discharge power amount calculation unit 250 is configured to calculate an amount of power discharged from the battery 12 to the outside of the vehicle 10 during the usage time. The virtual travel distance calculation unit 270 is configured to calculate the virtual travel distance by summing a movement distance stored in the movement distance storage unit 282, and a value obtained by converting an amount of power calculated by the discharge power amount calculation unit 250 into a movement distance.

The guarantee application determination unit 210 may determine whether the electrical equipment 14 that is operated, when the battery 12 included in the vehicle 10 is charged and discharged, satisfies the guarantee application condition. The limitation unit 240 is configured to limit a usage amount of the electrical equipment 14 for discharging from the battery 12 to the outside of the vehicle 10, to be lower than or equal to a first limit value, when the electrical equipment 14 satisfies the guarantee application condition. The limitation unit 240 is configured to limit, or not to limit the usage amount of the electrical equipment 14 for discharging from the battery 12 to the outside of the vehicle 10, to be lower than or equal to a second limit value which is higher than the first limit value, when the electrical equipment 14 does not satisfy the guarantee application condition.

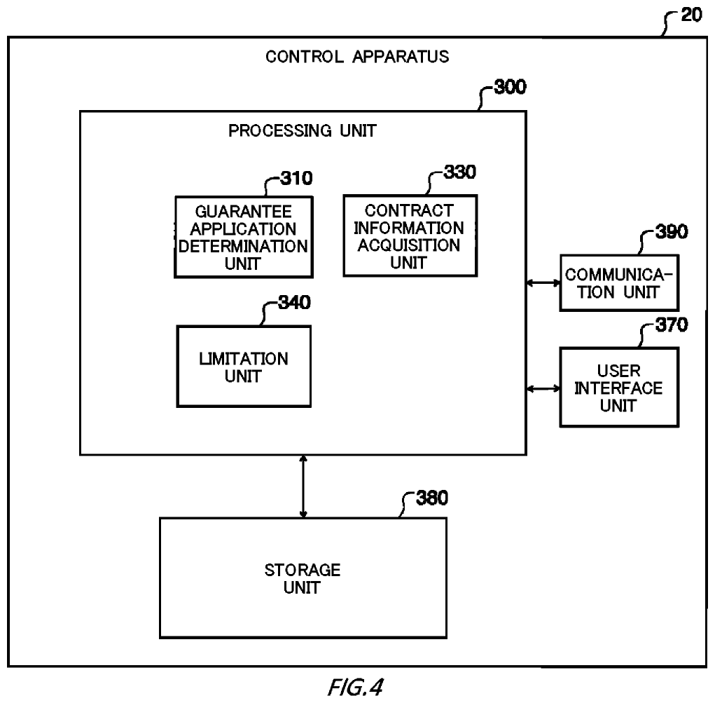

FIG. 4 shows an example of a system configuration of a control apparatus 20. The control apparatus 20 includes a processing unit 300, a storage unit 380, a communication unit 390, and a user interface unit 370.

The processing unit 300 controls the communication unit 390. The communication unit 390 is responsible for the communication between the aggregator server 180 and the vehicle 10. The processing unit 300 is realized by a calculation processing device including a processor. The storage unit 380 is realized by including each non-volatile storage medium. The processing unit 300 performs processing by using information stored in the storage unit 380. The processing unit 300 may be realized by a microcomputer including a CPU, a ROM, a RAM, an I/O, a bus, and the like.

The control apparatus 100 may be realized by a computer.

In the present embodiment, the control apparatus 100 is set to be realized by a single computer. However, in another embodiment, the control apparatus 100 may be realized by a plurality of computers. At least some functions of the control apparatus 100 may be realized by one or more servers, such as a cloud server.

The processing unit 300 includes a guarantee application determination unit 310, a limitation unit 340, and a contract information acquisition unit 330.

The communication unit 390 is configured to communicate with the control apparatus 100 that is configured to control the discharge from the battery 12 to the outside of the vehicle 10. The communication unit 390 is configured to acquire identification information from the control apparatus 100. The limitation unit 340 is configured to vary, according to the identification information, an operation of limiting the amount of power which is discharged from the battery 12 to the outside of the vehicle 10. The limitation unit 340 is configured to: limit the amount of power which is discharged from the battery 12 to the outside of the vehicle 10, to be lower than or equal to the first limit value, when the vehicle 10 is determined to satisfy the guarantee application condition, and the discharge from the battery 12 to the outside of the vehicle 10 is determined, from the identification information, to be controlled by the control apparatus 100 other than a predetermined specific control apparatus; and limit the amount of power which is discharged from the battery 12 to the outside of the vehicle 10, to be lower than or equal to a third limit value which is higher than the first limit value, when the vehicle is determined to satisfy the guarantee application condition, and the discharge from the battery 12 to the outside of the vehicle 10 is determined, from the identification information, to be controlled by the specific control apparatus. The contract information acquisition unit 330 is configured to acquire contract information relating to a durability guarantee for the battery 12. The limitation unit 340 is configured to determine whether to limit, according to the contract information, the amount of power which is discharged from the battery 12 to the outside of the vehicle 10, to be lower than or equal to the third limit value. The third limit value may be smaller than the second limit value.

The limitation unit 340 may limit the amount of power which is discharged from the battery 12 to the outside of the vehicle 10, to be lower than or equal to a limit value set by the user interface unit 370. The user interface unit 370 may be equipment having an HMI function.

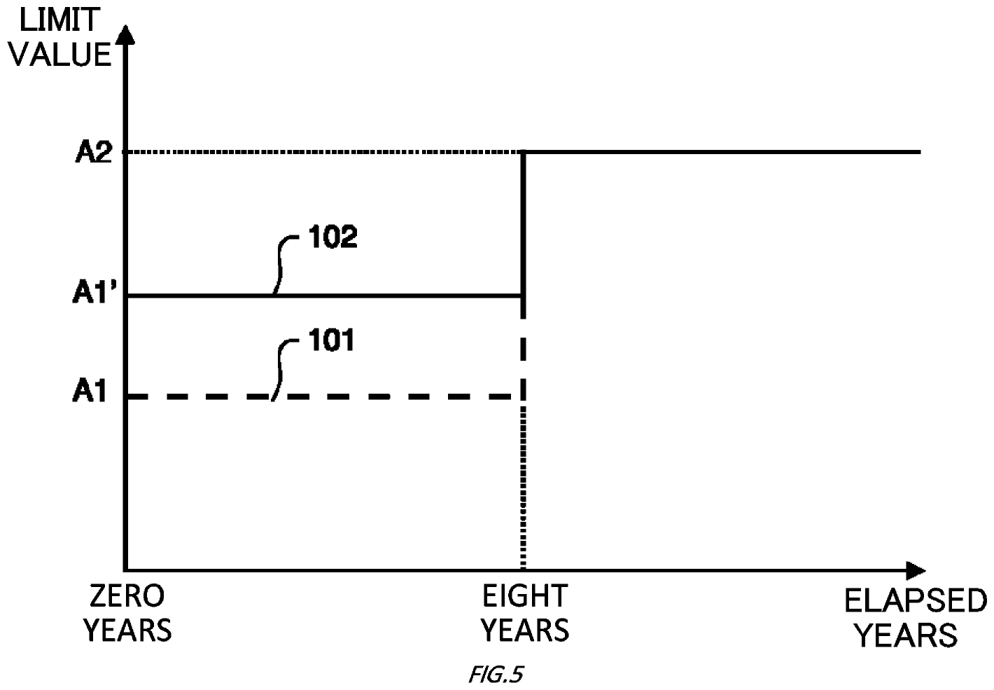

FIG. 5 shows an example of controlling, according to elapsed years, a limitation state of an amount of power which is transmitted and received between a battery 12 and a power grid 90. A vertical axis of a graph in FIG. 5 represents the limit value for the amount of power, and a horizontal axis represents the elapsed years from a start time of the guarantee application of the vehicle 10.

A line 101 in FIG. 5 represents a transition of the limit value for the vehicle 10 for which the power transmission and reception control between the battery 12 and the power grid 90 is determined to be performed by a first control under the guarantee application condition. The first control may be selected when an emphasis is put on maintaining a travel performance of the vehicle 10, and an incentive which is provided by transmitting and receiving the power between the battery 12 and the power grid 90 is acquired to some degree.

In this case, the limitation unit 240 limits the amount of power which is discharged from the battery 12 to the power grid 90, to be lower than or equal to a threshold value A1. For example, the limitation unit 240 limits the amount of power which is discharged from the battery 12 to the power grid 90 such that the amount of power which is discharged from the battery 12 to the power grid 90 is lower than or equal to A1 within a predetermined period. As an example, the limitation unit 240 may limit the amount of power which is discharged from the battery 12 to the power grid 90 per month, to be lower than or equal to A1.

As indicated by the line 101, when the guarantee application determination unit 210 determines that the guarantee application condition is satisfied, the limitation unit 240 limits the amount of power which is discharged from the battery 12 to the power grid 90, to be lower than or equal to A1. On the other hand, when the guarantee application determination unit 210 determines that the guarantee application condition is not satisfied, the limitation unit 240 switches the control of the amount of power which is discharged from the battery 12 to the power grid 90, to a second control to limit the amount of power to be lower than or equal to a predetermined threshold value A2 which is higher than A1.

For example, in a case where the guarantee application condition is that the elapsed years are less than eight years, the limitation unit 240 limits the amount of power which is discharged from the battery 12 to the power grid 90, to be lower than or equal to A1, when the elapsed years are less than eight years, and the limitation unit 240 limits the amount of power which is discharged from the battery 12 to the power grid 90, to be lower than or equal to A2, when the elapsed years are eight years or more.

A line 102 in FIG. 5 represents a transition of the limit value for the vehicle 10 for which the power transmission and reception control between the battery 12 and the power grid 90 is determined to be performed by a third control under the guarantee application condition. The third control may be selected when an emphasis is put on acquiring an incentive which is provided by transmitting and receiving the power between the battery 12 and the power grid 90, and a travel performance of the vehicle 10 is maintained to some degree.

In this case, the limitation unit 240 limits the amount of power which is discharged from the battery 12 to the power grid 90, to be lower than or equal to a threshold value A1′ which is higher than A1. For example, the limitation unit 240 limits the amount of power which is discharged from the battery 12 to the power grid 90 such that the amount of power which is discharged from the battery 12 to the power grid 90 is lower than or equal to A1′ within a predetermined period. As an example, the limitation unit 240 may limit the amount of power which is discharged from the battery 12 to the power grid 90 per month, to be lower than or equal to A1′.

As indicated by the line 102, when the guarantee application determination unit 210 determines that the guarantee application condition is satisfied, the limitation unit 240 limits the amount of power which is discharged from the battery 12 to the power grid 90, to be lower than or equal to A1′. On the other hand, when the guarantee application determination unit 210 determines that the guarantee application condition is not satisfied, the limitation unit 240 switches the control of the amount of power which is discharged from the battery 12 to the power grid 90, to the third control to limit the amount of power to be lower than or equal to A2 which is higher than A1′.

For example, in a case where the guarantee application condition is that the elapsed years are less than eight years, the limitation unit 240 limits the amount of power which is discharged from the battery 12 to the power grid 90, to be lower than or equal to A1′, when the elapsed years are less than eight years, and the limitation unit 240 limits the amount of power which is discharged from the battery 12 to the power grid 90, to be lower than or equal to A2, when the elapsed years are eight years or more.

In this manner, the battery 12 of the vehicle 10 in which the elapsed years are eight years or more can be used to be effectively utilized such that the adjustment capacity is provided to the power grid 90. Therefore, it is possible to maximally use the value of the battery 12 even after the guarantee application ends. It should be noted that in another embodiment, a mode in which the amount of power which is discharged from the battery 12 to the power grid 90 is not limited when the elapsed years are eight years or more may be adopted.

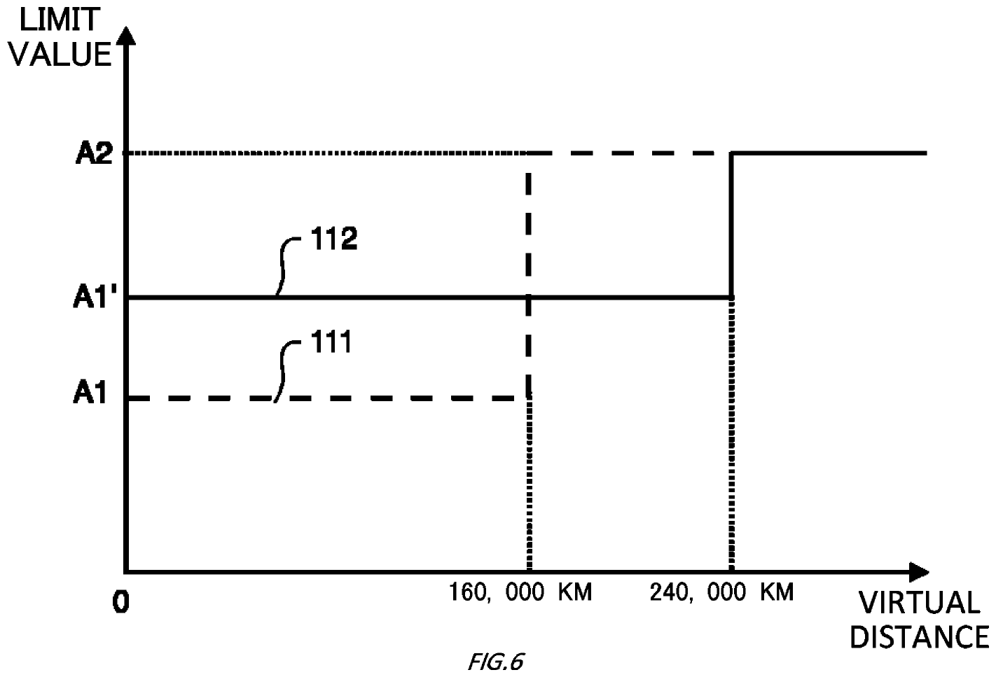

FIG. 6 shows an example of controlling, according to a virtual distance, the limitation state of the amount of power which is transmitted and received between the battery 12 and the power grid 90. A vertical axis of a graph in FIG. 6 represents the limit value for the amount of power, and a horizontal axis represents the virtual distance from the start time of the guarantee application of the vehicle 10. The virtual travel distance calculation unit 270 calculates the virtual distance by adding the travel distance of the vehicle 10, and a converted distance obtained by converting the amount of power discharged from the battery 12 to the power grid 90 into the travel distance of the vehicle 10 based on electricity consumption information of the vehicle 10. The travel distance of the vehicle 10 is calculated based on history information collected from the vehicle 10 to be stored in the movement distance storage unit 282.

A line 111 in FIG. 6 represents a transition of the limit value for the vehicle 10 for which the power transmission and reception control between the battery 12 and the power grid 90 is determined to be performed by the first control under the guarantee application condition. The limitation unit 240 limits the amount of power which is discharged from the battery 12 to the power grid 90, to be lower than or equal to A1, when the virtual distance is less than 160,000 km, and the limitation unit 240 limits the amount of power which is discharged from the battery 12 to the power grid 90, to be lower than or equal to A2, when the virtual distance is 160,000 km or more.

A line 112 in FIG. 6 represents a transition of the limit value for the vehicle 10 for which the power transmission and reception control between the battery 12 and the power grid 90 is determined to be performed by the third control under the guarantee application condition. The limitation unit 240 limits the amount of power which is discharged from the battery 12 to the power grid 90, to be lower than or equal to A1′, when the virtual distance is less than 240,000 km, and the limitation unit 240 limits the amount of power which is discharged from the battery 12 to the power grid 90, to be lower than or equal to A2, when the virtual distance is 240,000 km or more.

In this manner, the battery 12 of the vehicle 10 in which the virtual distance is greater than or equal to a specified distance can be used to be effectively utilized such that the adjustment capacity is provided to the power grid 90.

It should be noted that it is also possible to apply a guarantee condition in which the amount of power, instead of the virtual distance, is set as an index. In this case, the calculation is performed by converting the travel distance into the amount of power, based on the electricity consumption information, instead of converting the amount of power into the travel distance. Therefore, in the case of applying the guarantee condition in which the amount of power is set as an index, a content of the control is substantially similar to that in FIG. 6 because a unit of the horizontal axis of the graph in FIG. 6 only changes to the amount of power. Therefore, an illustration of the case of applying the guarantee condition in which the amount of power is set as an index, is omitted.

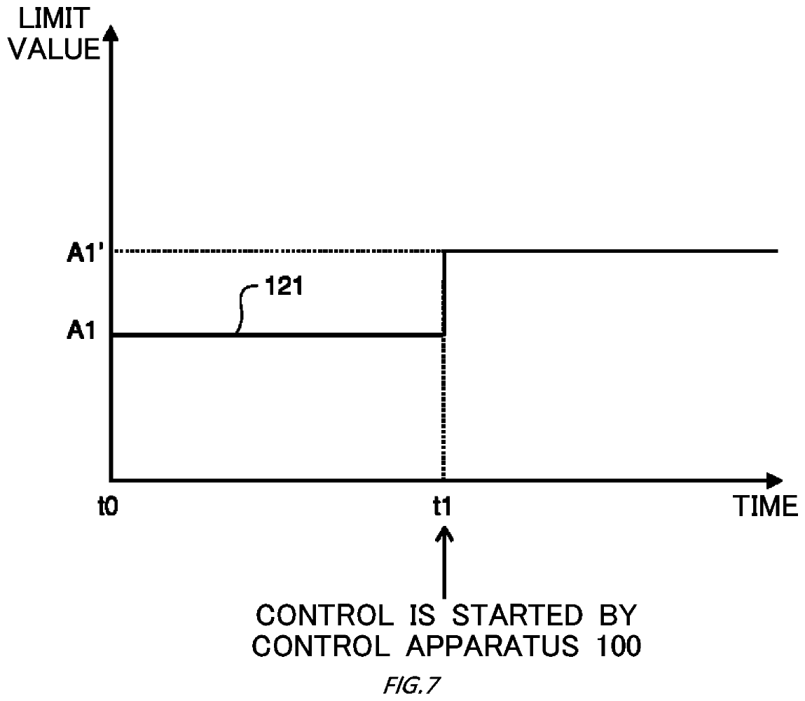

FIG. 7 shows a transition of a control value when a charge and discharge control of the battery 12 is performed by a control apparatus 170. In FIG. 7, the vehicle 10 in which the charge and the discharge of the battery 12 is controlled by the third control under the guarantee application condition, is described.

As indicated by a line 121, even when the guarantee application condition is satisfied, in a case where the charge and the discharge of the battery 12 is controlled by the control apparatus 170, the limitation unit 340 of the vehicle 10 limits the amount of power which is discharged from the battery 12 to the power grid 90, to be lower than or equal to A1. On the other hand, after a time t1, when the charge and the discharge of battery 12 can be determined to be controlled by the specific control apparatus 100, based on the predetermined identification information received from the control apparatus 100, the amount of power which is discharged from the battery 12 to the power grid 90 is limited to be lower than or equal to A1′ which is higher than A1. In this manner, when the battery 12 is controlled by the control apparatus 100 capable of appropriately controlling the battery 12, it is possible to more actively transmit and receive the power to and from the power grid 90, and on the other hand, when the battery 12 is controlled by the control apparatus 170 that cannot appropriately control the battery 12, it is possible to transmit and receive the power to and from the power grid 90 in a safe mode.

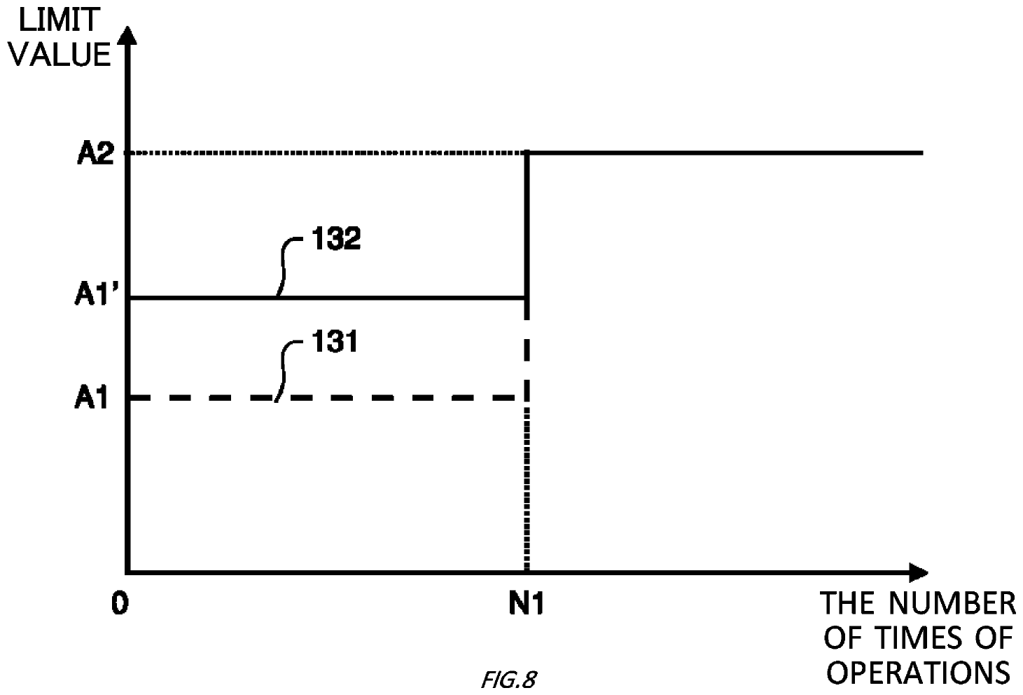

FIG. 8 shows an example of controlling, according to a usage amount of electrical equipment 14, the limitation state of the amount of power which is transmitted and received between the battery 12 and the power grid 90. A vertical axis of a graph in FIG. 8 represents the limit value for the amount of power, and a horizontal axis represents the number of times of operations of a switch included in the electrical equipment 14. FIG. 8 shows an example of a case where the guarantee application condition is that the number of times of the operations of the switch is less than N1.

A line 131 in FIG. 8 represents a transition of the limit value for the vehicle 10 for which the power transmission and reception control between the battery 12 and the power grid 90 is determined to be performed by the first control under the guarantee application condition. The limitation unit 240 limits the amount of power which is discharged from the battery 12 to the power grid 90, to be lower than or equal to A1, when the number of times of the operations of the switch is less than N1, and the limitation unit 240 limits the amount of power which is discharged from the battery 12 to the power grid 90, to be lower than or equal to A2, when the number of times of the operations of the switch is N1 or more.

A line 132 in FIG. 8 represents a transition of the limit value for the vehicle 10 for which the power transmission and reception control between the battery 12 and the power grid 90 is determined to be performed by the third control under the guarantee application condition. The limitation unit 240 limits the amount of power which is discharged from the battery 12 to the power grid 90, to be lower than or equal to A1′, when the number of times of the operations of the switch is less than N1, and the limitation unit 240 limits the amount of power which is discharged from the battery 12 to the power grid 90, to be lower than or equal to A2, when the number of times of the operations of the switch is N1 or more.

In this manner, the battery 12 of the vehicle 10 in which the number of times of the operations of the switch is N1 or more can be used to provide the adjustment capacity to the power grid 90. Therefore, the battery 12 can be effectively utilized.

It should be noted that as other information indicating the usage amount of the electrical equipment 14, it is possible to use the number of times of activations of control equipment or communication equipment included in the electrical equipment 14. As the other information indicating the usage amount of the electrical equipment 14, it is possible to use an operation time of control equipment or communication equipment included in the electrical equipment 14. In addition, as the information indicating the usage amount of the electrical equipment 14, it is possible to apply various pieces of information indicating durability or life spans of various types of components included in the electrical equipment 14.

Then, the limit value for limiting the amount of power which is discharged from the battery 12 to the power grid 90 is described.

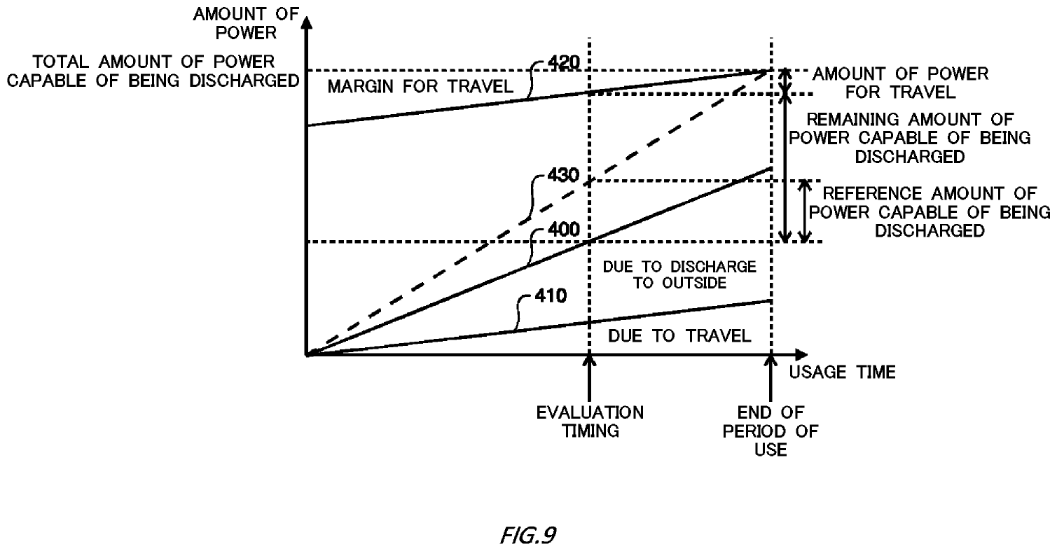

FIG. 9 is a diagram for describing a parameter which is used for a power transmission and reception control between the power grid 90 outside the vehicle 10, and the battery 12. A horizontal axis of a graph in FIG. 9 represents a time, and a vertical axis represents the amount of power. The origin of the horizontal axis is, for example, a time when the vehicle 10 is purchased. The vertical axis is set to represent the amount of power which is discharged from the battery 12. In the present embodiment, a period of use is set to the maximum number of the elapsed years satisfying the guarantee application condition. For example, the period of use is set to eight years.

In the present embodiment, the control apparatus 100 controls the charge and the discharge of the battery 12 such that an amount of power which is output by the battery 12 is lower than or equal to a predetermined total amount of power capable of being discharged from a start time of the use of the vehicle 10 to an end time of a specified period of use. The total amount of power capable of being discharged may be a value determined by a contract. For example, the total amount of power capable of being discharged in the vehicle 10 in which the battery 12 is controlled by the third control under the guarantee application condition, may be set to be smaller than a total amount of power capable of being discharged in the vehicle 10 in which the battery 12 is controlled by the first control under the guarantee application condition.

In FIG. 9, a line 400 represents the total amount of power which is output from the battery 12. A line 410 represents the amount of power which is output from the battery 12 due to the travel of the vehicle 10 (due to the travel). A difference between the line 400 and the line 410 represents the amount of power which is output from the battery 12 due to the operation of the vehicle 10 other than the travel. In the present embodiment, the difference between the line 400 and the line 410 represents the amount of power which is discharged from the battery 12 to the power grid 90 outside the vehicle 10 (due to the discharge to the outside).

A line 420 represents the amount of power which is to be secured for future travel of the vehicle 10 in the total amount of power capable of being discharged, which is capable of being output, by the battery 12 (a margin for the travel). A line 430 represents the amount of power which is assumed when the battery 12 is averagely used such that the power corresponding to the total amount of power capable of being discharged, is output from the battery 12 from the start time of the use of the vehicle 10 to the end time of the period of use. That is, when the battery 12 is used along the line 430, an integrated amount of power which is output by the vehicle 10 from the start time of the use of the vehicle 10 to the end time of the period of use, matches the total amount of power capable of being discharged. Reference information represented by the line 430 is stored in the storage unit 280.

The total discharge power amount calculation unit 260 calculates the power amount of the battery 12, due to the travel of the vehicle 10, at the end time of the period of use. The total discharge power amount calculation unit 260 may predict the amount of power of the battery 12 due to the travel of the vehicle 10 at the end time of the period of use, by extrapolating, until the end time of the period of use, a change in amount of power output from the battery 12 due to the travel of the vehicle 10 from the start time of the use of the vehicle 10 up to a current time. The value calculated by the total discharge power amount calculation unit 260 is a value of a sum of the amount of power output from the battery 12 due to the travel of the vehicle 10 up to the current time, and the amount of power for the travel in FIG. 9. The discharge power amount calculation unit 250 calculates the amount of power output from the battery 12 to the power grid 90 up to the current time.

The limitation unit 240 calculates a remaining amount of power capable of being discharged at a current evaluation timing. The limitation unit 240 calculates the remaining amount of power capable of being discharged by subtracting, from the total amount of power capable of being discharged, the amount of power calculated by the total discharge power amount calculation unit 260. The remaining amount of power capable of being discharged corresponds to an upper limit value at which the output is possible from the battery 12 to the power grid 90 until the end time of the period of use of the vehicle 10.

The limitation unit 240 calculates a reference amount of power capable of being discharged at a current evaluation timing. The limitation unit 240 refers to the reference information and calculates a current reference amount of power. The current reference amount of power is a current value on the line 430. The limitation unit 240 calculates the reference amount of power capable of being discharged by subtracting, from the reference amount of power, the amount of power output from the battery 12 due to the travel of the vehicle 10 up to the current time, and the amount of power output from the battery 12 to the power grid 90 up to the current time. The limitation unit 240 limits the charge and the discharge of the battery 12 based on the remaining amount of power capable of being discharged and the reference amount of power capable of being discharged.

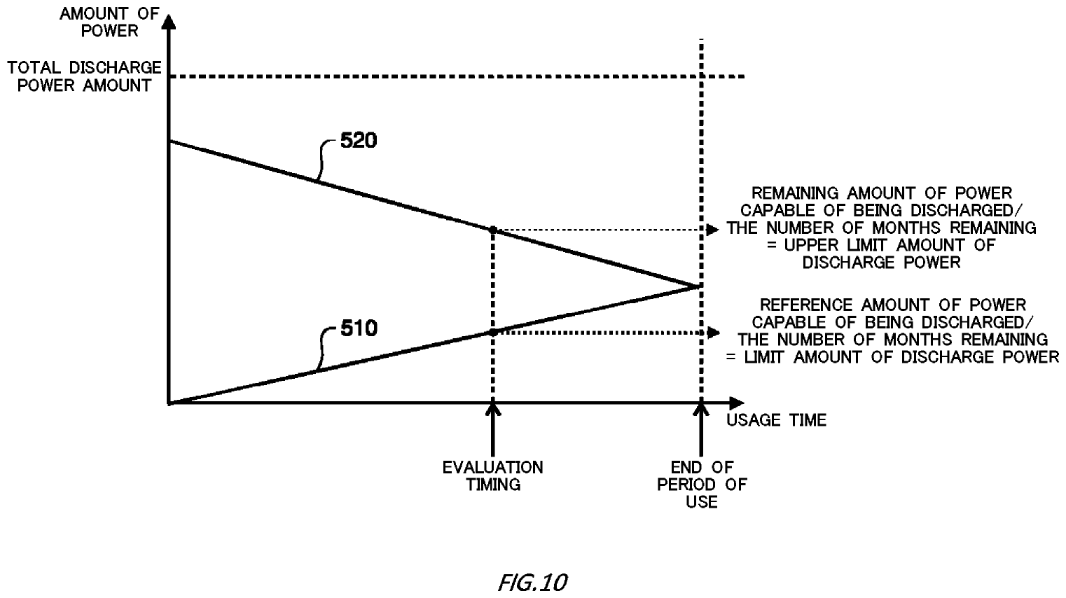

FIG. 10 conceptually shows changes in remaining amount of power capable of being discharged and in reference amount of power capable of being discharged. In FIG. 10, a line 520 represents the remaining amount of power capable of being discharged, and a line 510 represents the reference amount of power capable of being discharged.

The limitation unit 240 calculates an upper limit amount of discharge power by dividing the current remaining amount of power capable of being discharged by the number of months remaining until the end time of the period of use. The upper limit amount of discharge power corresponds to an amount of power which can be allowed to be output from the battery 12 to the power grid 90 per month. When the amount of power which is output from the battery 12 to the power grid 90 per month exceeds the upper limit amount of discharge power, the total amount of power capable of being discharged is exceeded by the end time of the period of use. Therefore, the limitation unit 240 controls the charge and the discharge of battery 12 such that the amount of power which is output from the battery 12 to the power grid 90 per month, does not exceed the upper limit amount of discharge power.

The limitation unit 240 calculates a limit amount of discharge power by dividing the current reference amount of power capable of being discharged by the number of months remaining until the end time of the period of use. When the amount of power which is output from the battery 12 to the power grid 90 per month exceeds the limit amount of discharge power, the line 430 in FIG. 9 is exceeded. Therefore, the limitation unit 240 controls the charge and the discharge of the battery 12 such that the amount of power which is output from the battery 12 to the power grid 90 per month, does not exceed the limit amount of discharge power as far as it is possible.

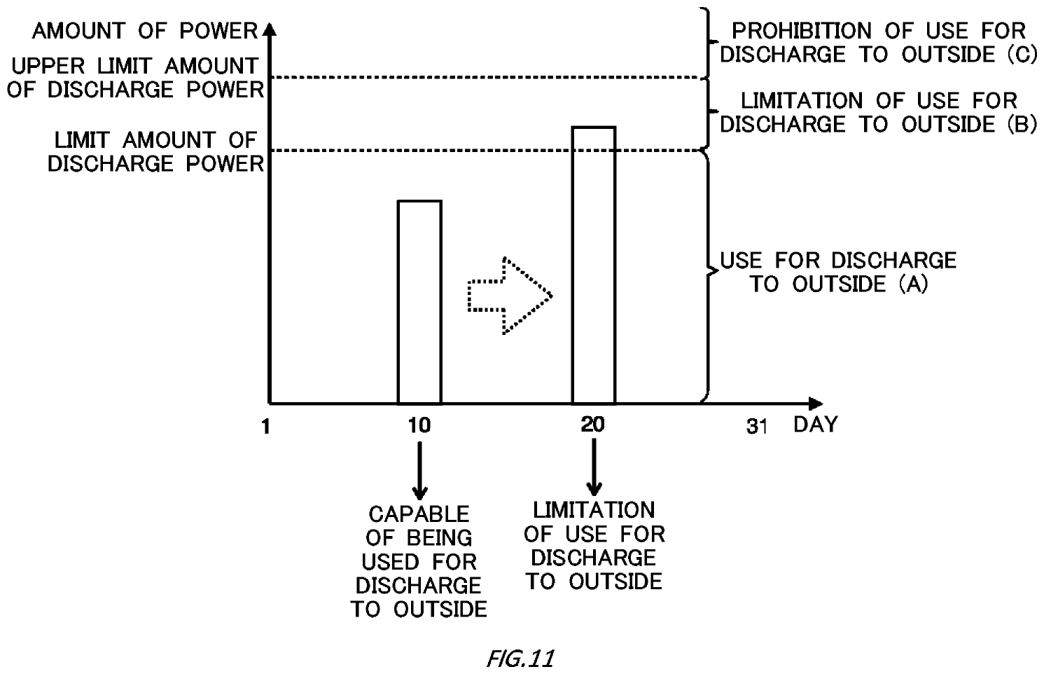

FIG. 11 is diagram for describing a control of a limitation unit 240. A vertical axis in FIG. 11 represents an amount of power output to the power grid 90 in a month. A horizontal axis represents the number of days in a month. The amount of power output from the battery 12 to the power grid 90 from the first day to the 10th day is less than the limit amount of discharge power. Therefore, the limitation unit 240 determines that the battery 12 can be used to discharge the power to the power grid 90 (a use for the discharge to the outside).

On the other hand, the amount of power output from the battery 12 to the power grid 90 from the first day to the 20th day exceeds the limit amount of discharge power. Therefore, the limitation unit 240 limits the use of the battery 12 for discharging the power to the power grid 90 (a limitation of the use for the discharge to the outside). For example, the limitation unit 240 uses the battery 12 to discharge the power to the power grid 90, on a condition that the amount of power which is required to be discharged to the power grid 90, cannot be discharged from another battery 12 determined to be for the “use for the discharge to the outside”. The limitation unit 240 does not use the battery 12 to discharge the power to the power grid 90, when the amount of power which is required to be discharged to the power grid 90, can be discharged from another battery 12 determined to be for the “use for the discharge to the outside”.

It should be noted that when the amount of power output from the battery 12 to the power grid 90 in a month exceeds the upper limit amount of discharge power, the limitation unit 240 prohibits the battery 12 from being used to discharge the power to the power grid 90 (a prohibition of the use for the discharge to the outside). In addition, in FIG. 11, a sign A indicates that the battery 12 may be preferentially selected to discharge the power to the power grid 90. A sign B indicates that the battery 12 may be selected, with a limitation, to discharge the power to the power grid 90. A sign C indicates that the battery 12 may not be selected to discharge the power to the power grid 90. In this way, the signs A, B, and C indicate the priorities of using the battery 12 to discharge the power to the power grid 90. Specifically, the signs show that A has a higher priority than B and that B has a higher priority than C.

This makes it possible for the limitation unit 240 to control the battery 12 such that the amount of power discharged by the battery 12 of the vehicle 10 to the power grid 90 reaches the total amount of power capable of being discharged at the end time of the period of use of the vehicle 10.

With reference to FIG. 9 to FIG. 11, the method of using the total amount of power capable of being discharged, and setting the monthly limit amount of discharge power and the upper limit amount of discharge power, to control the charge and the discharge of the battery 12, has been above described. When this control method is applied, a mode in which a first total amount of power capable of being discharged is applied as the limit value for the vehicle 10 to which the first control is applied under the guarantee condition, and a third total amount of power capable of being discharged, which is greater than the first total amount of power capable of being discharged, is applied as the limit value for the vehicle 10 to which the third control is applied under the guarantee condition, may be adopted. In addition, in the second control which is applied when the guarantee application condition is not satisfied, a second total amount of power capable of being discharged, which is greater than the third total amount of power capable of being discharged, may be applied as the limit value.

As described above, with the control by the control apparatus 100 and the control apparatus 20, it is possible to maximally use the value of the battery 12 even after the guarantee application condition of the vehicle 10 is no longer satisfied. Thereby, it is possible to maximally use the value of the battery 12.

In the present embodiment, the control apparatus 100 is set to be provided outside the vehicle 10 and control the vehicle 10 through the communication network 190. However, a mode in which the control apparatus 20 of the vehicle 10 has at least some function of the functions of the control apparatus 100 may be adopted.

The vehicle 10 may be an electric motor vehicle including an electric vehicle, a hybrid vehicle, and a saddle riding type vehicle such as an electric motorized bicycle. The vehicle 10 is an example of a moving object. The moving object may be any moving object that includes a battery and moves on land and that is other than a vehicle. The moving object may include an aircraft such as an unmanned aerial vehicle (UAV), a ship, and the like.

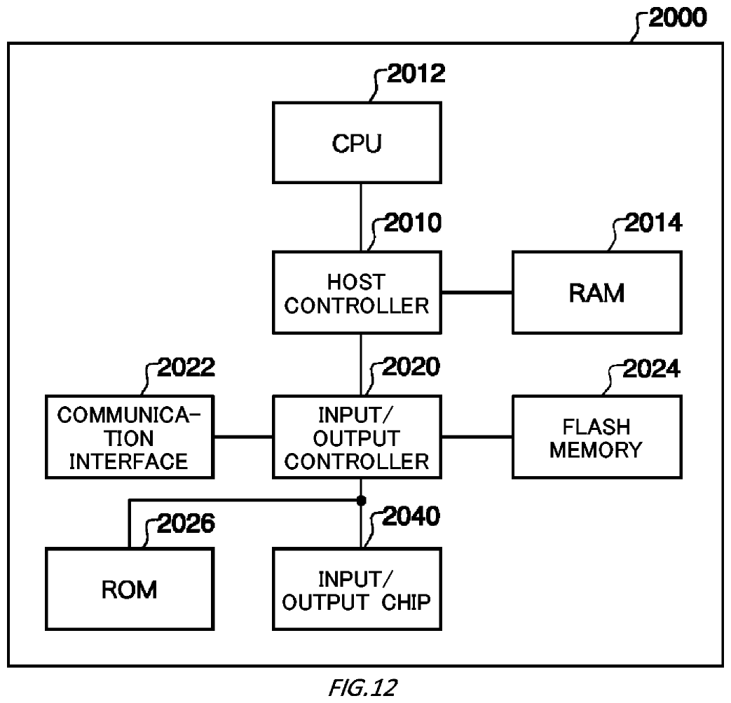

FIG. 12 shows an example of a computer 2000 in which a plurality of embodiments of the present invention may be entirely or partially embodied. A program installed on the computer 2000 can cause the computer 2000 to function as a system or each unit of the system according to the embodiment, or the control apparatus 100 or an apparatus such as the control apparatus 100 or each unit of the apparatus, or to execute an operation associated with the system or each unit of the system, or the apparatus or each unit of the apparatus, and/or to execute a process or steps of the process according to the embodiment. Such a program may be executed by a CPU 2012 to cause the computer 2000 to perform certain operations associated with the processing procedures described herein and some of or all of the blocks in the block diagrams.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, thereby controlling each unit.

The communication interface 2022 communicates with other electronic devices via a network. The flash memory 2024 stores programs and data used by the CPU 2012 within the computer 2000. The ROM 2026 stores therein a boot program or the like executed by the computer 2000 at the time of activation, and/or a program depending on the hardware of the computer 2000. In addition, the input/output chip 2040 may connect various input/output units such as a keyboard, a mouse, and a monitor to the input/output controller 2020 via input/output ports such as a serial port, a parallel port, a keyboard port, a mouse port, a monitor port, a USB port, and an HDMI (registered trademark) port.

A program is provided via a network or computer-readable storage media such as a CD-ROM, a DVD-ROM, or a memory card. The RAM 2014, the ROM 2026, or the flash memory 2024 is an example of a computer-readable storage medium. Programs are installed in the flash memory 2024, the RAM 2014, or the ROM 2026, and executed by the CPU 2012. The information processing written in these programs is read by the computer 2000, and thereby cooperation between a program and the above-described various types of hardware resources is achieved. An apparatus or method may be constituted by carrying out the operation or processing of information by using the computer 2000.

For example, when a communication is carried out between the computer 2000 and an external device, the CPU 2012 may execute a communication program loaded onto the RAM 2014, and instruct the communication interface 2022 to process the communication, based on the processing written in the communication program. The communication interface 2022, under control of the CPU 2012, reads transmission data stored on transmission buffering regions provided in recording media such as the RAM 2014 and the flash memory 2024, and transmits the read transmission data to a network and writes reception data received from a network to reception buffering regions or the like provided on the recording media.

In addition, the CPU 2012 may cause all or a necessary portion of a file or a database to be read into the RAM 2014, the file or the database having been stored in a recording medium such as the flash memory 2024, etc., and perform various types of processing on the data on the RAM 2014. The CPU 2012 then writes back the processed data to the recording medium.

Various types of information, such as various types of programs, data, tables, and databases, may be stored in the recording medium to undergo information processing. The CPU 2012 may perform various types of processing on the data read from the RAM 2014, which includes various types of operations, information processing, conditional judging, conditional branch, unconditional branch, retrievals/replacements of information, etc., as described herein and designated by an instruction sequence of programs, and writes the result back to the RAM 2014. In addition, the CPU 2012 may search for information in a file, a database, etc., in the recording medium. For example, when a plurality of entries, each having an attribute value of a first attribute associated with an attribute value of a second attribute, are stored in the recording medium, the CPU 2012 may search for an entry matching the condition whose attribute value of the first attribute is designated, from among the plurality of entries, and read the attribute value of the second attribute stored in the entry, thereby acquiring the attribute value of the second attribute associated with the first attribute satisfying the predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage media. A program stored in the computer-readable storage medium may be provided to the computer 2000 via a network.

A program, which is installed on the computer 2000 and causes the computer 2000 to function as the control apparatus 100, may work on the CPU 2012 or the like to cause the computer 2000 to function as each unit of the control apparatus 100. Information processing written in these programs functions as each unit of the control apparatus 100 that is specific means by which software and the above described various types of hardware resources cooperate by being read by the computer 2000. Then, by the specific means realizing calculation or processing of information according to a purpose of use of the computer 2000 in the present embodiment, the specific control apparatus 100 according to the purpose of use is constructed.

A program, which is installed on the computer 2000 and causes the computer 2000 to function as the control apparatus 20, may work on the CPU 2012 or the like to cause the computer 2000 to function as each unit of the control apparatus 20. Information processing written in these programs functions as each unit of the control apparatus 20 that is specific means by which software and the above described various types of hardware resources cooperate by being read by the computer 2000. Then, by the specific means realizing calculation or processing of information according to a purpose of use of the computer 2000 in the present embodiment, the specific control apparatus 20 according to the purpose of use is constructed.

Various embodiments have been described by referring to the block diagrams and the like. In the block diagram, each block may represent (1) a step of a process in which an operation is executed, or (2) each unit of the apparatus having a role of executing the operation. Certain steps and respective units may be implemented by dedicated circuitry, programmable circuitry supplied with computer-readable instructions stored on computer-readable storage media, and/or processors supplied with computer-readable instructions stored on computer-readable storage media. Dedicated circuitry may include digital and/or analog hardware circuits and may include integrated circuits (IC) and/or discrete circuits. Programmable circuitry may include reconfigurable hardware circuits including logical AND, logical OR, logical XOR, logical NAND, logical NOR, and other logical operations, flip-flops, registers, memory elements, etc., such as field-programmable gate arrays (FPGA), programmable logic arrays (PLA), etc.

The computer-readable storage medium may include any tangible device that can store instructions for execution by a suitable device, and as a result, the computer-readable storage medium having instructions stored therein forms at least a portion of an article of manufacture including instructions which can be executed to create means for performing processing procedures or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instruction may include an assembler instruction, an instruction-set-architecture (ISA) instruction, a machine instruction, a machine dependent instruction, a microcode, a firmware instruction, state-setting data, or either of source code or object code written in any combination of one or more programming languages including an object-oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, special purpose computer, or other programmable data processing device, or to programmable circuitry, locally or via a local area network (LAN), wide area network (WAN) such as the Internet, etc., to execute the computer-readable instructions to provide means for performing described processing procedure or operations specified in the block diagrams. Examples of the processor include a computer processor, a processing unit, a microprocessor, a digital signal processor, a controller, a microcontroller, and the like.

While the present invention has been described with the embodiments, the technical scope of the present invention is not limited to the above described embodiments. It is apparent to persons skilled in the art that various alterations and improvements can be added to the above-described embodiments. It is also apparent from the description of the claims that the embodiments to which such alterations or improvements are made can be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, specification, or drawings, it does not necessarily mean that the process must be performed in this order.

### EXPLANATION OF REFERENCES

5: system, 10: vehicle, 12: battery, 14: electrical equipment, 20: control apparatus, 30: charging and discharging facility, 42: dwelling unit, 44: facility, 70: power consumer, 80: power generation apparatus, 90: power grid, 100: control apparatus, 170: control apparatus, 180: aggregator server, 190: communication network, 200: processing unit, 210: guarantee application determination unit, 240: limitation unit, 250: discharge power amount calculation unit, 260: total discharge power amount calculation unit, 270: virtual travel distance calculation unit, 280 storage unit, 282: movement distance storage unit, 290: communication unit, 300: processing unit, 310: guarantee application determination unit, 340: limitation unit, 330: contract information acquisition unit, 370: user interface unit, 380: storage unit, 390: communication unit, 2000: computer, 2010: host controller, 2012: CPU, 2014: RAM, 2020: input/output controller, 2022: communication interface, 2024: flash memory, 2026: ROM, 2040: input/output chip.

What is claimed is:

1. A control apparatus comprising:
a guarantee application determination unit configured to determine whether a battery included in a moving object satisfies a predetermined guarantee application condition; and
a limitation unit configured to limit an amount of power which is discharged from the battery to an outside of the moving object, to be lower than or equal to a first limit value, when the battery satisfies the guarantee application condition, wherein
the limitation unit is configured to limit, or not to limit the amount of power which is discharged from the battery to the outside of the moving object, to be lower than or equal to a second limit value which is higher than the first limit value, when the battery does not satisfy the guarantee application condition.

2. The control apparatus according to claim 1, wherein
the guarantee application determination unit is configured to determine that the guarantee application condition is not satisfied when a usage time from a start date of use of the moving object is greater than or equal to a predetermined value, when a virtual travel distance is greater than or equal to a predetermined value, or when a total amount of discharge of the battery is greater than or equal to a predetermined threshold value.

3. The control apparatus according to claim 2, further comprising:
a movement distance storage unit configured to store a movement distance of the moving object during the usage time;
a discharge power amount calculation unit configured to calculate an amount of power discharged from the battery to the outside of the moving object during the usage time; and
a total discharge power amount calculation unit configured to calculate the total amount of discharge by summing a value obtained by converting a movement distance stored in the movement distance storage unit into an amount of power, and an amount of power calculated by the discharge power amount calculation unit.

4. The control apparatus according to claim 2, further comprising:
a movement distance storage unit configured to store a movement distance of the moving object during the usage time;
a discharge power amount calculation unit configured to calculate an amount of power discharged from the battery to the outside of the moving object during the usage time; and
a virtual travel distance calculation unit configured to calculate the virtual travel distance by summing a movement distance stored in the movement distance storage unit, and a value obtained by converting an amount of power calculated by the discharge power amount calculation unit into a movement distance.

5. The control apparatus according to claim 1,
the control apparatus being provided in the moving object,
the control apparatus further comprising a communication unit configured to communicate with a control apparatus that is configured to control a discharge from the battery to the outside of the moving object, wherein
the communication unit is configured to acquire identification information from the control apparatus, and
the limitation unit is configured to vary, according to the identification information, an operation of limiting the amount of power which is discharged from the battery to the outside of the moving object.

6. The control apparatus according to claim 5, wherein
the limitation unit is configured to
limit the amount of power which is discharged from the battery to the outside of the moving object, to be lower than or equal to the first limit value, when the moving object is determined to satisfy a guarantee application condition, and the discharge from the battery to the outside of the moving object is determined, from the identification information, to be controlled by a control apparatus other than a predetermined specific control apparatus, and limit the amount of power which is discharged from the battery to the outside of the moving object, to be lower than or equal to a third limit value which is higher than the first limit value, when the moving object is determined to satisfy the guarantee application condition, and the discharge from the battery to the outside of the moving object is determined, from the identification information, to be controlled by the specific control apparatus.

7. The control apparatus according to claim 6, further comprising:
a contract information acquisition unit configured to acquire contract information relating to a durability guarantee for the battery, wherein
the limitation unit is configured to determine whether to limit, according to the contract information, the amount of power which is discharged from the battery to the outside of the moving object, to be lower than or equal to the third limit value.

8. The control apparatus according to claim 6, wherein
the third limit value is smaller than the second limit value.

9. The control apparatus according to claim 1, further comprising:
a user interface unit, wherein
the limitation unit is configured to limit the amount of power which is discharged from the battery to the outside of the moving object, to be lower than or equal to a limit value set by the user interface unit.

10. The control apparatus according to claim 2,
the control apparatus being provided in the moving object,
the control apparatus further comprising a communication unit configured to communicate with a control apparatus that is configured to control a discharge from the battery to the outside of the moving object, wherein
the communication unit is configured to acquire identification information from the control apparatus, and
the limitation unit is configured to vary, according to the identification information, an operation of limiting the amount of power which is discharged from the battery to the outside of the moving object.

11. The control apparatus according to claim 3,
the control apparatus being provided in the moving object,
the control apparatus further comprising a communication unit configured to communicate with a control apparatus that is configured to control a discharge from the battery to the outside of the moving object, wherein
the communication unit is configured to acquire identification information from the control apparatus, and
the limitation unit is configured to vary, according to the identification information, an operation of limiting the amount of power which is discharged from the battery to the outside of the moving object.

12. The control apparatus according to claim 4,
the control apparatus being provided in the moving object,
the control apparatus further comprising a communication unit configured to communicate with a control apparatus that is configured to control a discharge from the battery to the outside of the moving object, wherein
the communication unit is configured to acquire identification information from the control apparatus, and
the limitation unit is configured to vary, according to the identification information, an operation of limiting the amount of power which is discharged from the battery to the outside of the moving object.

13. The control apparatus according to claim 10, wherein
the limitation unit is configured to
limit the amount of power which is discharged from the battery to the outside of the moving object, to be lower than or equal to the first limit value, when the moving object is determined to satisfy a guarantee application condition, and the discharge from the battery to the outside of the moving object is determined, from the identification information, to be controlled by a control apparatus other than a predetermined specific control apparatus, and
limit the amount of power which is discharged from the battery to the outside of the moving object, to be lower than or equal to a third limit value which is higher than the first limit value, when the moving object is determined to satisfy the guarantee application condition, and the discharge from the battery to the outside of the moving object is determined, from the identification information, to be controlled by the specific control apparatus.

14. The control apparatus according to claim 1, wherein the moving object is a vehicle.

15. A moving object comprising the control apparatus according to claim 1.

16. A control apparatus comprising:
a guarantee application determination unit configured to determine whether electrical equipment that is operated, when a battery included in a moving object is charged and discharged, satisfies a guarantee application condition; and
a limitation unit configured to limit a usage amount of the electrical equipment for discharging from the battery to an outside of the moving object, to be lower than or equal to a first limit value, when the electrical equipment satisfies the guarantee application condition, wherein the limitation unit is configured to limit, or not to limit the usage amount of the electrical equipment for the discharging from the battery to the outside of the moving object, to be lower than or equal to a second limit value which is higher than the first limit value, when the electrical equipment does not satisfy the guarantee application condition.

17. The control apparatus according to claim 16, wherein
the electrical equipment includes a switch component that is configured to operate when the battery is discharged to the outside of the moving object.

18. The control apparatus according to claim 16, wherein
the moving object is a vehicle.

19. A moving object comprising the control apparatus according to claim 16.

20. A method comprising:
determining whether a battery included in a moving object satisfies a predetermined guarantee application condition;
limiting an amount of power which is discharged from the battery to an outside of the moving object, to be lower than or equal to a first limit value, when the battery satisfies the guarantee application condition; and
limiting, or not limiting the amount of power which is discharged from the battery to the outside of the moving object, to be lower than or equal to a second limit value which is higher than the first limit value, when the battery does not satisfy the guarantee application condition.
